(19) United States
(12) Patent Application Publication
(10) Pub. No.: US 2011/0042002 A1
(43) Pub. Date: Feb. 24, 2011

(54) Fastening element for fastening to a base body and method for fastening said fastening element

(76) Inventors: Norman Blank, Ruschlikon (CH); Juergen Finter, Zurich (CH); Urs Burckhardt, Zurich (CH)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/594,912

(22) PCT Filed: Mar. 29, 2005
(86) PCT No.: PCT/EP05/51409

§ 371 Date: Mar. 22, 2010

(30) Foreign Application Priority Data
Mar. 29, 2004 (EP) 04007529.3

(51) Int. Cl. B32B 37/12; C09J 7/02; C09J 175/04; C09J 133/08; C09J 163/00; B32B 5/16; B32B 33/00

(52) U.S. Cl. 156/307.1; 428/343; 428/355 N; 428/355 AC; 428/355 EP; 428/354; 428/323; 428/40.1; 428/321.1

(57) ABSTRACT

The invention relates to a fixing element for fixing to a base body, in particular to building surfaces comprising a support and an reactive adhesive.

### TECHNICAL FIELD

The invention concerns a fastening element for affixing to a base as in the generic part of the first claim. The invention also concerns a method for affixing a fastening element as in the generic part of the independent claims concerning the method.

### PRIOR ART

To attach objects, especially in construction, fastening elements, for example mounting bolts, of some kind are secured in the base material by anchoring. For example, a hole is drilled in a concrete wall, a dowell is inserted, and the mounting bolts are screwed into the dowell, or the bolts are embedded or glued into the hole. However, this is very costly and requires a number of steps. With other base materials the affixing is in some cases even more difficult, since these materials, for instance steel, ceramic or class, are difficult to work.

There are indeed securing systems that use thermoplastic adhesives, but these have low load capacity, and the bond is not permanent.

### PRESENTATION OF INVENTION

The invention is based on the task of enabling a simple and reliable attachment with a fastening element for securing it to a base and a method for affixing a fastening element of the kind mentioned at the start.

In accordance with the invention, this is achieved through the traits of the first claim.

The core of the invention therefore is that the fastening element consists of a mounting support and a reactive adhesive.

The advantages of the invention can be seen, among other things, in the fact that a simple and reliable application is enabled through the fastening element in accordance with the invention. Moreover, this application is possible on all substrates, since the reactive adhesive can easily be matched to said substrates. Moreover, the application of such fastening elements is much simpler and more reliable than with the traditional methods.

It is especially expedient when particles that react to alternating fields are arranged in the adhesive. In this way rapid hardening of the adhesive by means of alternating fields is possible.

Moreover, it is especially expedient when one-component adhesives with blocking are used. These adhesives enable simple application. The adhesives are extremely storage stable because of the blocking of resin and/or hardener, preferably resin and hardener, and they are not susceptible to moisture. Rapid hardening can be achieved by radiation-induced heating of the adhesive without heating the surroundings. Such adhesives, moreover, have good mechanical strength that can be set in a wide range. These advantages also arise with two-component adhesives, although they must be kept separately and must be able to be dispensed easily.

Other advantageous embodiments of the invention result from the dependent claims.

### BRIEF DESCRIPTION OF THE DRAWINGS

Embodiment examples of the invention are explained in more detail below by means of drawings. Like elements in the different figures are indicated with the same reference numbers.

Here:

FIG. 1 shows a schematic representation of the fastening element in accordance with the invention;

FIG. 2 shows a schematic representation of a fastening element with an auxiliary adhesive;

FIG. 3 shows a schematic representation of a fastening element with rupturing elements;

FIG. 4 shows a schematic representation of the adhesive from FIG. 3 with packaged components;

FIG. 5 shows another schematic representation of the adhesive from FIG. 3 with packaged components;

FIG. 6 shows a schematic representation of a fastening element with an additional primer layer.

Only the elements that are important for immediate understanding of the invention are shown. Not shown, for example, are the alternating field generator as well as pertinent machines.

### METHODS OF EMBODIMENT OF INVENTION

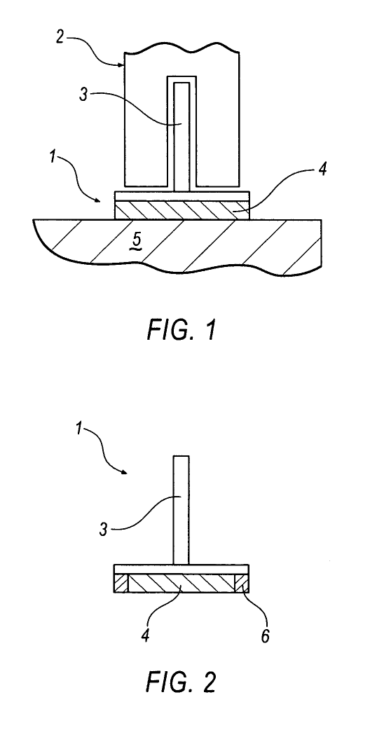

In this invention a storage-stable reactive adhesive system is used to secure a fastening element to a base element. In accordance with FIG. 1, such a fastening element 1 consists of a mounting support 3 and a reactive adhesive 4. The fastening element 1 is secured to base element 5 by means of a fastening device. It goes without saying that the fastening element can have any shape, and can and must be matched to the elements that are to be fastened onto it in each case.

Many different systems can be used for the reactive adhesive. However, an important point of this invention is that the fastening element can be affixed to the base element as rapidly as possible, i.e., the application of the fastening element takes as little time as possible. For this, on the one hand, the reactive adhesive can be designed so that rapid hardening takes place, and on the other hand the fastening element can be held on the base element with another adhesive 6 (FIG. 2) until the reactive adhesive has produced sufficient adhesive effect.

Reactive adhesives that can be used for the invention are indicated below. Of course, other adhesives can also be used if they have the required properties.

### EXAMPLES OF REACTIVE ADHESIVES

One-Component Systems

A one-component reactive adhesive that can be used for the invention is a storage-stable polymer composition that is characterized by the fact that it contains at least one resin A that enters into polyreactions, at least one, especially a blocked, hardener B, at least one type of nanoparticle C with ferromagnetic, ferrimagnetic, superparamagnetic or piezoelectric properties, at least one additive D, and optionally other components, where preferably at least one of the components A or B is in blocked form. Upon application of electrical, magnetic and/or electromagnetic alternating fields the nanoparticles C are stimulated, so that their environment is greatly heated through the transfer of energy. As a consequence of this local temperature elevation the components A and/or B become activated through deblocking or capsule rupture, so that the reactive adhesive rapidly hardens.

In a first embodiment the one-component reactive adhesive is a polyurethane composition. It is characterized by the fact that it contains, as resin A that enters into polyreactions, a polyurethane polymer that contains a free or blocked isocyanate group. The term “polymer” in this document means on the one hand a collective of chemical uniform macromolecules that, however, differ in degree of polymerization, molecular weight and chain length, which was prepared by a polyreaction (polymerization, polyaddition, polycondensation). On the other hand, the term “polymer” in this document also includes derivatives of such a collective of macromolecules from polyreactions, therefore compounds that were obtained by reactions, for example additions or substitutions, of functional group to the said macromolecules and which can be chemically uniform or chemically heterogeneous.

The term “polymer composition” in this document is used to mean a homogeneous or heterogeneous mixture of substances that consists of one or more polymers or contains polymers in a considerable amount.

The term “polyurethane” in this document means all polymers that are prepared by the diisocyanate polyaddition process. This also included polymers that are nearly or entirely free of urethane group, for instance polyether polyurethanes, polyester polyurethane, polyether polyureas, polyureas, polyester polyureas, polyisocyanurates, polycarbodiimides, etc.

The prefix “poly” in the names of substances like “polyol”, “polyisocyanate” or “polyamine” in this document indicates that the relevant substance formally contains more than one of the functional groups that occur in its name per molecule.

The isocyanate group-containing polyurethane polymer is prepared by the reaction of at least polyol with at least one polyisocyanate. This reaction can take place by reacting the polyol and the polyisocyanate with conventional methods, for example at temperature of 50° C. to 100° C., optionally with the co-use of suitable catalysts, where the polyisocyanate is dispensed so that its isocyanate groups are present in stoichiometric excess with respect to the hydroxyl group of the polyol. The excess of polyisocyanate is chosen so that in the resulting polyurethane polymer, after the reaction of all of the hydroxyl groups of the polyol, there remains, for example, a certain content of free isocyanate group of 0.1-15 wt %, preferably 0.5-5 wt %, with respect to the entire polyurethane polymer. Optionally, the polyurethane polymer can be prepared with the co-use of plasticizers, where the plasticizers that are used do not contain group that have reactivity for isocyanates.

For example, the following commercial polyols or any mixtures thereof can be used as polyols for the preparation of such an isocyanate group-containing polyurethane polymer:

polyoxyalkylene polyols, also called polyether polyols, which are polymerization producers of ethylene oxide, 1,2-propylene oxide, 1,2- or 2,3-butyfene oxide, tetrahydrofuran, or mixtures thereof, possible polymerized with the help of a starter molecule having two or more active hydrogen atoms such as water, ammonium or compounds with several OH or NH group such as 1,2-ethanediol, 1,2- and 1,3-propanediol, neopentyl glycol, diethylene glycol, triethylene glycol, the isomeric dipropylene glycols and tripropylene glycols, the isomeric butandiols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and mixture of the said compounds. Both polyoxyalkylene polyols that have a low degree of unsaturation (measured by ASTM D-2849-69 and given in milliequivalents of unsaturation per gram of polyol (meq/g)), which were prepared for example with the help of the so called double metal cyanide complex catalysts (DMC Catalysts), as well as polyoxyalkylene polyols with a higher degree of unsaturation, which are prepared, for example, with the help of anionic catalysts like NaOH, KOH or alkali alcoholates, can be used. Polyoxyalkylenediols or polyoxyalkylenetriols especially polyoxypropylenediols or polyoxypropylenetriols, are especially suitable.

Particularly suitable are polyoxyalkylenediols or polyoxyalkylenetriols with a degree of unsaturation lower than 0.02 meq/g and a molecular weight in the range of 1000 to 30000 g/mol, and polyoxypropylenediols and -triols with molecular weight from 400 to 8000 g/mol. “Molecular weight” or “mol weight” are understood in this document to always mean the weight average molecular weight Mₙ.

Likewise especially suitable are the so called “EO-end capped” (ethylene oxide end capped) polyoxypropylenediols or -triols. The latter are particular polyoxypropylene polyoxyethylene polyols, which are obtained, for example, by alkoxylating polyoxypropylene polyols with ethylene oxide after the end of the polypropoxylation and which because that have primary hydroxyl group.

Styrene-acrylonitrile graft polyether polyols, such as are sold by Bayer under the name Lupranol.

Polyester polyols, prepared, for example, for di- or trihydric alcohols such as 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the said alcohols with organic dicarboxylic acids or their anhydrides or esters such as succinic acid, glutaric acid, adipic acid, suberic acid, sebacic acid, dodecanedicarboxylic acid, maleic acid, fumaric acid, phthalic acid, isophthalic acid, terephthalic acid and hexahydrophthalic acid or mixtures of said acids, and polyester polyols of lactones such as ε-caprolacton.

Polycarbonate polyols, as are accessible by the reaction of, for example, the alcohols indicated above (used to synthesize the polyester polyols) with dialkyl carbonates, diaryl carbonates or phosgene.

Polyacrylate and polymethacrylate polyols.

Polyhydroxy-terminated polybutadiene polyols such those that are prepared by polymerization of 1,3-butadiene and allyl alcohol.

Polyhydroxy terminated acrylonitrile/polybutadiene copolymers, as can be prepared, for example, from epoxides or amino alcohols and carboxyl-terminated acrylonitrile/polybutadiene -copolymers (commercially available under the name Hycar® CTBN from Hanse Chemie). These polyols have an average molecular weight of 250 to 30,000 g/mol, especially 1000 to 30,000 g/mol, and an average OH functionality in the range of 1.6 to 3.

In addition to these polyols, low-molecular di- or polyhydric alcohols such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimer fatty alcohols, 1,1,1-trimethylolethane, 1,1,1-trimethylolpropane, glycerol, pentaerythritol, sugar alcohols and other more highly hydric alcohols, low-molecular alkoxylation products of the said di- and polyhydric alcohols and mixtures of the said alcohols can be co-used in the preparation of the polyurethane polymer.

Commercial polyisocyanates are used as polyisocyanates for the preparation of such an isocyanate group-containing polyurethane polymer. The following polyisocyanates, the best known in polyurethane chemistry, may be mentioned as examples:

2,4- and 2,6-toluene diisocyanate (TDI) and any mixtures of these isomers, 4,4′-d diphenylmethane diisocyanate (MDI), the diphenylmethane diisocyanate positional isomers, 1,3- and 1,4-phenylene diisocyanate, 2,3,5,6-tetramethyl-1,4-diisocyanatobenzene, 1,6-hexamethylenediisocyanate (HDI), 2-methylpentamethylene 1,6-diisocyanate, 2,2,4- and 2,4,4-trimethyl-1,6-hexamethylene diisocyanate (TMDI), 1,12-dodecamethylene diisocyanate, cyclohexane-1,3- and 1,4-diisocyanate any mixtures of these isomers, 1-isocyanato-3,3,5-trimethyl-5-isocyanatomethylcyclohexane (=isophorone diisocyanate or IPDI), perhydro-2,4′- and -4,4′-diphenylmethane diisocyanate (HMDI), 1,4-diisocyanato-2,2,6-trimethylcyclohexane (TMCDI), m- and p-xylylene diisocyanate (XDI), 1,3-and 1,4-tetramethylxylylene diisocyanate (TMXDI), 1,3- and 1,4-bis(isocyanatomethyl)cyclohexane, and oligomers and polymers of the said isocyanates, and any mixtures of the said isocyanates. MDI, TDI, HDI and IPDI and their mixtures are especially preferred. MDI and TDI and their mixtures are most preferred.

In a preferred embodiment the isocyanate group-containing polyurethane polymer is blocked. The blocking takes place by reacting the isocyanate group-containing polyurethane polymer with a blocking agent. The reaction preferably takes place by mixing the Isocyanate group-containing polyurethane polymer with the blocking agent in a stoichiometric ratio with respect to the content of isocyanate group and causing it to react at a temperature of 20 to 120° C. until almost no free isocyanate groups can be detected. If desired, a catalyst can also be used, for example a tin or bismuth compound.

Examples of suitable blocking agents are phenols like phenol, cresol, xylenol, p-ethylphenol, o-isopropylphenol, p-tert-butylphenol, p-tert-octylphenol, nonylphenol, dodecylphenol, thymol, p-naphthol, p-nitrophenol, p-chlorophenol, 2-pyridinol; phenol group-containing hydrocarbon resins like cumaron-indene resins, petroleum resins, terpene resins; alcohols like methanol, ethanol, propanol, isopropanol, butanol, 2-butanol, isobutanol, ethylene glycol, ethylene glycol methyl ether (Methyl Cellosolve®), ethylene glycol butyl ether (Butyl Cellosolve®), ethylene glycol phenyl ether (Phenyl Cellosolve®) diethylene glycol monomethyl ether (Methyl Carbito®), diethylene glycol monobutyl ether (Butyl Carbitol®), benzyl alcohol, furfuryl alcohol, cyclohexanol; 1,3-dicarbonyl compounds like dimethyl malonate, diethyl malonate, diethyl methylmalonate, ethyl acetoacetate, 2,4-pentanedione; mercaptans like butylmercaptans, hexylmercaptans, dodecylmercaptans, thiophenol, 2-mercaptopyridine; carboxylic amides like acetamide, acetanilide, acetaniside, benzamide; carboxylic imides like succinimide, maleimide; amines like diisopropylamine, dicyclohexylamine, N-tert-butyl-N-benzylamine, 2,6-dimethyl piperidine, diphenylamine, phenylnaphthylamine, aniline, 9H-carbazole; nitrogen heterocycles like imidazole, 2-methylimidazole, 2-ethylimidazole, benzimidazole, pyrazole, 3,5-dimethylpyrazole, 1,2,4-triazole, benzotriazole; ureas like urea, thiourea, imidazolidin-2-one; aldoximes like formaldoxime, acetaldoxime; ketoximes like methyl ethyl ketoxime, methyl isopropyl ketoxime, methyl isobutyl ketoxime, methyl amyl ketoxime, diisopropyl ketoxime, cyclohexaonoxime; lactams like ε-caprolactam, δ-valerolactam, γ-butyrolactam, β-propiolactam; imines like ethyleneimine; N-hydroxysuccinimide; 2-benzoxazolone, 1,3-benzoxazin-2,4-dion; bisulfites like sodium bisulfite, potassium bisulfite; and other blocking agents, as are mentioned in the two review articles by D. A. Wicks and Z. W. Wicks, Jr., “Blocked Isocyanates,” published in Organic Coatings 36 (1999), 148-172 and Progress in Organic Coatings 41 (2001), 1-83/Phenols, hydrocarbon resins, alcohols, oximes, nitrogen heterocycles, 1,3-dicarbonyl compounds, amines and lactams are preferred as blocking agents. Methyl ethyl ketoxime, methyl isobutyl ketoxime, pyrazole, 3,5-dimethyl pyrazole, 1,2,4-triazole, benzotriazole, dimethyl malonate, diethyl malonate diisopropylamine, dicyclohexylamine, N-tert-butyl-N-benzylamine and ε-caprolactam are especially preferred.

As hardener B the polyurethane composition contains a hardener that contains group that are reactive towards isocyanates and that are in blocked faun, where the blocking can be of chemical or physical nature. Examples of suitable chemically blocked hardeners are polyamines bound to metals via a complexing compound, especially complex compounds of methylenedianiline (MDA) and sodium chloride. Such complex compounds are usually described with the empirical formula (MDA)₃·NaCl. One suitable type is available as a dispersion in diethylhexyl phthalate under the trade name Caytur® 21 from Crompton Chemical. The complex breaks down upon heating to 80-160° C. at a rate that increases with higher temperature, through which the methylenedianiline is released as the active hardener. Examples of physically blocked hardeners are microencapsulated hardeners. Di- or polyhydric alcohols like 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimer fatty alcohols, 1,1,1-trimethylolethane, 1,1,1-trimethylolpropane, glycerol, pentaerythritol, sugar alcohols, low molecular alkoxylation products of the said di- and polyhydric alcohols; short-chain polyester polyols like terephthalic acid his glycol ester; aliphatic, cycloaliphatic and aromatic amine alcohols like ethanolamine, propanolamine, butanolamine, n-methylethanolamine, diethanolamine, triethanolamine; hydrazides of dicarboxylic acids; aliphatic polyamines like ethylenediamine, 1,2- and 1,3-propanediamine, 2-methyl-1,2-propanediamine, 2,2-dimethyl-1,3-propanediamine, 1,3- and 1,4-butanediamine, 1,3- and 1,5-pentanediamine, 1,6-hexamethylenediamine, 2,2,4- and 2,4,4-trimethyl hexamethylenediamine and mixtures thereof, 1,7-heptanediamine, 1,8-octanediamine, 4-aminomethyl-1,8-octanediamine, 1,9-nonanediamine, 1,10-decanediamaine, 1,11-undecanediamine, 1,12-dodecanediamine, methylbis(3-aminopropyl)amine, 1,5-diamino-2-methylpentane (MPMB), 1,3-diaminopentane (DAMP), 2,5-dimethyl-1,6-hexamethylenediamine, dimer fatty acid diamines; cycloaliphatic polyamines like 1,2-,1,3- and 1,4-diaminocyclohexane, bis(4-aminocyclohexyl)-methane, bis(4-amino-3-methylcyclohexyl)methane, bis(4-amino-3-ethylcyclohexyl)methane, bis(4-amino-3,5-dimethylcyclohexyl)methane, 1-amino-3-aminomethyl-3,5,5-trimethylcyclohexane (=isophorondiamine or IPDA, 2- and 4-methyl-1,3-diaminocyclohexane and mixtures thereof, 1,3- and 1,4-bis(aminomethyl)cyclohexane, 1-cyclohexylamino-3-aminopropane, 2,5(2,6)-bis(aminomethyl)bicyclo[2.2.1]heptane (NBDA), produced by Mitsui Chemicals), 3(4),8(9)-bis(aminomethyl)tricyclo[5.2.1.0²,6]decane, 1,4-diamino-2,2,6-trimethylcyclohexane (TMCDA), 3,9-bis(3-aminopropyl)-2,4,8,10-tetraoxaspiro[5.5]undecane, 1,3- and 1,4-xylylenediamine; ether group-containing aliphatic polyamines like bis(2-aminoethyl) ether, 4,7-dioxadecane-1,10-diamine, 4,9-dioxadodecane-1,12-diamine and higher oligomers thereof, polyoxyalkylenepolyamines with theoretically two or three amino group, which obtainable for example under the trade name Jeffamine® (produced by Huntsman Chemicals); aromatic polyamines like methylenedianiline, diaminophenyl ether, diaminodiphenylsulfone, the isomeric phenylenediamines, aminodiphenylamine are especially suitable for use as hardeners in microencapsulated form. Said aliphatic, cycloaliphatic and aromatic polyamines are preferred. The microencapsulation of these hardeners can be done by one of the current processes, for example by spray drying, interfacial polymerization coacervation, immersion or centrifuging processes, fluidized bed process, vacuum encapsulation, electrostatic microencapsules have a particle size of 0.1 to 100 micrometers, especially 0.3 to 50 micrometers. The size of the microcapsules is determined so that on the one hand they officially open up on heating and on the other hand after hardening the adhesive obtains optimum homogeneity and thus cohesive strength. It must not exert any harmful effect on the adhesion properties of the adhesive. Possibilities as material for the capsule shell are polymers that are insoluble in the resin that is to be encapsulated and that have a melting point from 40 to 200° C. Examples of suitable polymers are hydrocarbon waxes, polyethylene waxes, wax esters, polyesters, polyamides, polyacrylates, polymethacrylates of a number of such polymers.

In a preferred embodiment both the isocyanate group containing polyurethane polymer and the hardener are present in blocked form in the polyurethane composition.

In a second embodiment the one-component reactive adhesive is an acrylate composition. Such a composition is characterized by the fact that it contains as the resin A that enters into polyreactions at least one divalent or polyvalent monomer that contains an acryl or methacryl group and at least one monomer that contains monofunctional acryl or methacryl group. Examples of suitable di- or polyvalent monomers that contain an acryl or methacryl group are acrylates and methacrylates of aliphatic polyether polyurethanes and polyester polyurethanes, polyethers, polyesters, novolaks, di- and polyvalent aliphatic, cycloaliphatic and aromatic alcohols, glycols and phenols. Examples of monomers that contain a monofunctional acryl or methacryl group are methylacrylate and methacrylate, ethylacrylate and methacrylate, hexylacrylate and methacrylate, dodecylacrylate and methacrylate, tetrahydrofurfuryl acrylate and methacrylate, as well as hydroxyl group-containing acrylates and methacrylates like 2-Hydroxyethyl acrylate and methacrylate and, 2-hydroxypropyl acrylate and methacrylate.

As hardener B, the acrylate composition contains a thermal initiator that initiates the polymerization of the acrylate or methacrylate monomers and that is in blocked form. Examples of suitable thermal initiators are diacyl peroxides like benzoyl peroxide, lauroyl peroxide and decanoyl peroxide; peroxydicarbonates like dipropyl peroxydicarbonate; peroxyoxalates like di-tert-butyl peroxyoxalate; hyponitrites like di-tert-butyl hyponitrite. Benzoyl peroxide is preferred. The blocked thermal initiator, especially benzoyl peroxide, is preferably in microencapsulated form. The preparation of microencapsulated organic peroxides is described in EP 0 730 493 B1, for example.

In a third embodiment the one-component reactive adhesive is an epoxide composition. Such a composition is characterized by the fact that it contains as the resin A that enters into polyreactions at least one polyepoxide. Examples of suitable polyepoxides are diglycidyl or polyglycidyl ethers of polyhydric aliphatic, cycloaliphatic or aromatic alcohols, polyalkylene glycols, phenols like bisphenol A or of condensation products of phenol with formaldehyde that are obtained under acid conditions such as phenol novolaks and cresol novolaks; polyglycidyl esters of polyvalent carboxylic acids; and N-glycidyl derivatives of amines, amides and heterocyclic nitrogen bases. Glycidylized novolaks, hydantoins, aminophenols, bisphenols or aromatic diamines are preferred.

As hardener B, the epoxide composition contains a hardener that contains groups that are reactive toward epoxides and that are in blocked form. Examples of suitable hardeners are amines such as aliphatic, cycloaliphatic, aromatic or araliphatic, preferably primary or secondary, amines and polyamines; adducts and polyalkoxylation products of polyamines; amine-terminated polyalkylene glycols; adducts of monophenols or polyphenols with polyamides; polyamides, especially ones that derive from aliphatic polyamines and dimerized or trimerized fatty acids; polysulfides; aniline-formaldehydes; polyhydric phenols; polyvalent carboxylic acids and their anhydrides. Polyamines and polyaminoamides are preferred hardeners.

The one-component reactive adhesive additionally contains at least one type of nanoparticles “C” with ferromagnetic, ferrimagnetic, superparamagnetic or piezoelectric properties. The term “nanoparticle” in this document designates particles that have crystalline structures and an average particle size or diameter of less than 500 nm, especially less than 200 nm, preferably less than 50 nm, and especially preferably between 3 and 30 nm. In particular, in order to be able to utilize the properties provided by superparamagnetism, the particle size should not be much over 30 nm. The nanoparticles are stimulated by electrical, magnetic and/or electromagnetic alternating fields, so that their surroundings, the matrix of the reactive adhesive, is highly heated locally through transfer of energy. The nanoparticles of piezoelectric substances such as quartz, tourmaline, barium titanate, lithium sulfate, sodium tartrate, potassium tartrate, Seignette salt, ethylenediamine tartrate, lead titanate, lead zirconate, lead-zirconium titanates, lead-zirconium-lanthanum titanates, or ferroelectrics with Perovskite structure are suitable for use of electrical alternating fields. Nanoparticles of substances with ferrimagnetic, ferromagnetic or superparamagnetic properties, especially the metals aluminum, iron, cobalt, nickel and alloys of these metals, and metal oxides of the maghemite (γ-Fe₂O₃), and magnetite (FeO·Fe₂O₃) types and especially iron oxide mixtures, the so called ferrites of the general formula M¹¹O·Fe₂O₃, where M stands for one or more metals of the group consisting of manganese, zinc, copper, cobalt, magnesium, calcium or cadmium, are suitable for the use of magnetic alternating fields. Such ferrites have Curie temperatures that can be adjusted over a wide range by means of the metal composition. The Curie temperature is the maximum temperature to which a magnetic substance can be heated by the application of a magnetic or electromagnetic alternating field, and it thus corresponds to an intrinsic protection against overheating. Preferably, the Curie temperature lies in the range of 100 to 200° C.

Superparamagnetic nanoparticles with a narrow particle size distribution from 1 to 15 nm, which are characterized by having no hysteresis or remanence, are especially suitable. Such nanoparticles lead to clearly more efficient energy transfer and heating rates by the particles and the adhesive matrix surrounding them.

In order to guarantee good dispersibility of the nanoparticles in the adhesive matrix and to prevent agglomeration and coalescence of the nanoparticles during storage of adhesive, the nanoparticles C that are used are preferably surface-modified or coated, or are surrounded by a nonmagnetic, dispersible matrix, preferably pyrogenic oxides of silicon, aluminum, titanium, zirconium or magnesium. The preparation of suitable surface-modified nanoparticles is described in WO 03/54102, for example. The preparation of suitable nanoparticles surrounded by pyrogenic oxides is described EP 1 284 485, for example. The nanoparticles are contained in the reactive adhesive in an amount of 0.1 to 5 wt %, preferably 0.3 to 3 wt %, especially preferably 0.5 to 2 wt %, with respect to all of the adhesive.

The one-component reactive adhesive additionally contains at least one additive D. For example, the following auxiliary substances and additives are possibilities as suitable additives:

Plasticizers, for example esters of organic carboxylic acids or their anhydrides, phthalates, for example dioctyl phthalate or diisodecyl phthalate, adipates, for example dioctyl adipate, sebacates, organic phosphoric and sulfonic acid esters, polybutenes and other compounds that do not react with isocyanates; reactive diluents and cross linking agents, for example polyhydric alcohols, polyamines, polyaldimines, polyketimines or aliphatic isocyanates, for example 1,6-hexamethylene diisocyanate, 2,2,4- and 2,4,4-trimethyl-1,6-hexamethylene diisocyanate, 1,12-dodecamethylene diisocyanate, cyclohexane 1,3- and 1,4-diisocyanate and any mixtures of these isomers, 1-isocyanato-3,3,5-trimethyl-5-isocyanatomethyl-cyclohexane (=isophorone diisocyanate or IPDI), perhydro-2,4′- and -4,4′-diphenylmethane diisocyanate, 1,3- and 1,4-tetramethylxylylene diisocyanate, isocyanurates of these isocyanates, oligomers and polymers of these isocyanates, and their adducts with polyols; inorganic and organic fillers, for example ground or precipitated calcium carbonates, which are optionally coated with stearates, especially finely divided coated calcium carbonate, carbon blacks, kaolins, aluminum oxides, silicic acids and PVC powders or hollow beads; fibers, for example of polyethylene; pigments; catalysts for the reaction of isocyanate group, for example organotin compounds like dibutltin diacetate, dibutyltin dilaurate, dioctyltin dicarboxylate, dibutyltin dichloride, dibutyltin diacetylacetonate, alkyltin thioesters, organobismuth compounds or bismuth complexes, tertiary amines such as 2,2′-dimorpholinodiethyl ether; polyaldimines, polyketimins or polyoxazolidines; catalysts for the hydrolysis of aldimine, ketimine and oxazolidine group, for example organic carboxylic acids like benzoic acid or salicylic acid, organic carboxylic anhydrides like phthalic anhydride or hexahyrophthalic anhydride, silyl esters of organic carboxylic acids, organic sulfonic acids like p-toluenesulfonic acid or 4-dodecylbenzenesulfonic acid, or other organic or inorganic acids or mixtures of said acids; catalysts for the reaction of the epoxide group such as salicylic acid, dicyanodiamide, tertiary amines or quaternary ammonium compounds, Mannich bases, imidazoles and boron trifluoride or its complexes with organic compounds like ethers and amines, optionally in blocked form; catalysts for acceleration of the acrylate polymerization, for example tertiary amines like N,N-dimethylaniline, N,N-dimethyl-p-toluidine, N,N-dimethylbenzylamine and N-alkylmorpholine, thioureas like 1,3-diethylthiourea, or complexes or salts of nickel, cobalt and copper, and combinations of these catalysts; rheology modifiers such as thickeners or thixotropic agents, for example urea compounds, polyamide waxes, bentonites or pyrogenic silicic acids; auxiliary adhesives, especially silanes like alkylsilanes, epoxyalkylsilanes, vinylsilanes, aldiminoalkylsilanes, methacryloxyalkylsilanes and isocyanatoalkylsilanes, and oligomeric forms; waxes; drying agents, for example p-tosyl isocyanate and other reactive isocyanates, orthoformic acid esters, calcium oxide or molecular sieves; stabilizers to protect against heat, light and UV radiation; flame retardants; surface-active substances, for example wetting agents, flow aids, deairing agents or antifoaming agents; fungicides or mold inhibitors; as well as other substances that are usually used in reactive adhesives. It is clear to the specialist which auxiliary substances and additives are suitable for the relevant form of use of the reactive adhesive.

Such one-component adhesives are simple to use. Because of the blocking of the resin and/or hardener they are extremely storage-stable. In the preferred embodiments they are not susceptible to moisture because of the blocking of resin A and/or hardener B. They harden rapidly under the effect of electrical, magnetic and/or electromagnetic alternating fields. They have good mechanical strength, and these properties can be adjusted over a wide range.

### EXAMPLES OF REACTIVE ADHESIVES

Two-Component Systems

In the case of two-component systems one component must be kept separate from the other component and be released in a controlled way in the application. The reactive adhesive thus consists of a resin and a hardener, where both components are separated by a membrane. This membrane must be destroyed in the application, preferably by mechanical means. Various methods can be used to separate the two components by membrane:

a) microencapsulation of one component, p b) adsorption of each component separately in a foam or nonwoven material and optionally separating them by membrane,

c) enclosing each component in a container of thin plastic film.

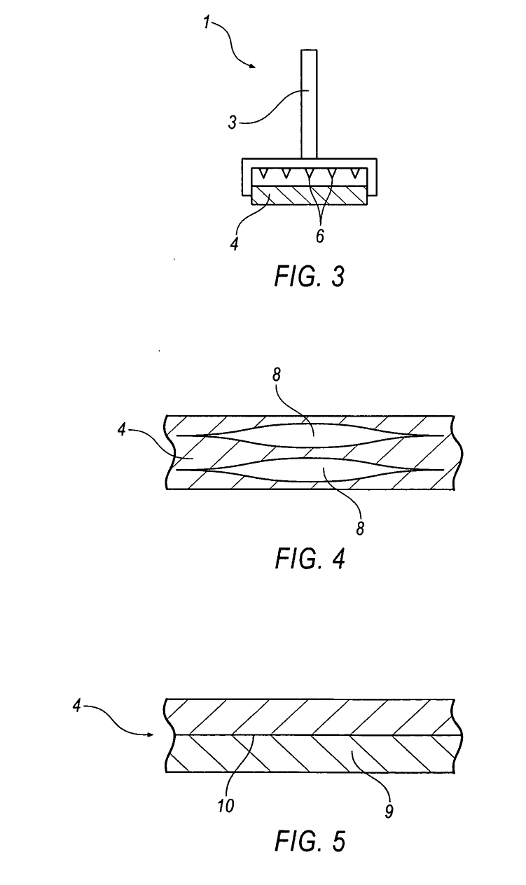

FIG. 3 shows a fastening element in accordance with the invention that additionally has rupturing element 7, in this case sharp points. If the components are kept in containers 8 as shown in FIG. 4, especially containers of a thin film, or in absorbent materials like nonwovens that are optionally separated by membrane 10, as shown in FIG. 5, these components can be released by the rupturing means. This is shown here as mechanical rupture by the sharp points, which punch holes in the membranes upon use. However, the release of the components can also take place by any other means.

A viscosity <7000 mPa·sec is necessary for thorough mixing of the components. The viscosity can be set by an increase of temperature. This increase of temperature can take place by introduction of microwaves or by induction, and the absorption of energy can be improved by absorbent particles in the adhesive formulation such as electrically conductive particles or nano- or microscale ferrites, as was also described above in the examples for the one-component systems.

The storage-stable reactive adhesives that are in the form of separated components can be based, for example on:

### 1) Epoxide Resins and Hardeners

Any epoxide resins can be used here as the epoxide resin; preferably, the epoxide resin contains at least two epoxide groups in the molecule. Suitable epoxide resins are especially those with more than one epoxide group, β-methylglycidyl group or 2,3-epoxycyclopentyl group that are bonded to a heteroatom, for example sulfur, but preferably oxygen or nitrogen, especially bis(2,3-epoxycyclopentyl) ether, diglycidyl or polyglycidyl ethers of polyhydric aliphatic or aromatic alcohols like 1,4-butanediol, or polyalkylene glycols like polypropylene glycol; diglycidyl or polyglycidyl ethers of cycloaliphatic polyols like 2,2-bis(4-hydroxycyclohexyl)propane; diglycidyl or polyglycidyl ethers of polyhydric phenols like resorcinol, bis(p-hydroxyphenyl)methane, 2,2-bis(p-hydroxyphenyl)propane (bisphenol-A), 2,2-bis(4′-hydroxy-3′,5′-dibromophenyl)propane and 1,1,2,2-tetrakis(p-hydroxyphenyl)ethane, or of condensation products of phenols with formaldehydes, that are obtained under acid conditions such as phenol novolaks and cresol novolaks and the di(β-methylglycidyl) or poly(β-methylglycidyl) ethers of said polyhydric alcohols or phenols. In addition, polyglycidyl esters of polyvalent carboxylic acids like phthalic acid, terephthalic acid, tetrahydrophthalic acid and hexahydrophthalic acid, the N-glycidyl derivates of amines, amides and heterocyclic nitrogen bases like N,N-diglycidylaniline, N,N-diglycidyltoluidine, N,N,O-triglycidyl-p-aminophenol, N,N,N′,N′-tetraglycidyl-bis(p-aminophenyl)methane and triglycidyl isocyanurate.

Glycidylized novolaks, hydantoins, aminophenols, bisphenols or aromatic diamines are a preferred group of the epoxide resins. As resin, preferred compositions also contain a glycidylized cresol novolak, bisphenol-A diglycidyl ether or a bisphenol-A diglycidyl ether that has been lengthened, for example with bisphenol-A, dimer fatty acids or a mixture thereof, and their mixtures with aliphatic diglycidyl ethers.

Possible epoxide hardeners are acid or base compounds. Examples of suitable hardeners are amines like aliphatic, cycloaliphatic, aromatic or araliphatic, preferably primary or secondary amines such as ethylenediamine, hexamethylenediamine, trimethylhexamethylenediamine, diethylenetriamine, triethylenetetramine, tetraethylenepentamine, N,N-dimethylpropylene-1,3-diamine, N,N-diethylpropylene-1,3-diamine, 2,2-bis(4′-aminocyclohexyl)propane, 3,5,5-trimethyl-3-(aminomethyl)cyclohexylamine (isophoronediamine), m-phenylenediamine, p-phenylenediamine, bis(4-aminophenyl)methane, bis(4-aminophenyl)sulfon and m-xylylenediamine; adducts of polyalkylenepolyamines, for example diethylenetriamine or triethylenetetramine, with acrylonitrile or monoepoxides such as ethylene oxide or propylene oxide; amine-terminated polyalkylene glycols, for example those obtainable under the name Jeffamine® (Huntsman); adducts of polyamines, like diethylenetriamine or triethylenetetramine, with polyepoxides, like bisphenol-A diglycidyl ether, prepared with an excess of said polyamines; adducts of monophenols or polyphenols with polyamides; polyamides, especially those that derive from aliphatic polyamines such as diethylenetriamine or triethylenetetramine, and dimerized or trimerized fatty acids (for example, Versamide®, of dimerized linoleic acid); polysulfides, for example those obtainable under the name Thiokol® aniline formaldehydes; polyhydric phenols, for example resorcinol, 2,2-bis(4-hydroxyphenyl)propane or phenolformaldehyde resins (novolaks); polyvalent carboxylic acid and their anhydrides, for example phthalic anhydride, tetrahydrophthalic anhydride, hexahydrophthalic anhydride, 4-methylhexahydrophthalic anhydride, 3,6-endomethylenetetrahydrophthalic anhydride, 4-methyl-3,6-endomethylene-4-tetrahydrophthalic anhydride (methylnadic anhydride), succinic anhydride, adipic anhydride, trimethyladipic anhydride, sebacic anhydride, maleic anhydride, dodecylsuccinic anhydride, pyromellitoc anhydride, trimallitic anhydride, benzophenonetetracarboxylic dianhydride, or mixtures of anhydrides. Amines and polyaminoamides are preferred hardeners.

The composition can also contain accelerators or hardening catalysts. Examples are: tertiary amines or quaternary ammonium compounds, Mannich bases like 2,4,6-tris(dimethylaminomethyl)phenol, benzyldimethylamine, 2-ethyl-4-methylimidazole, monophenols or polyphenols like phenol and bisphenol-A, salicylic acid, dicyanodiamide, boron trifluoride and its complexes with organic compounds like ethers and amines, for example BF₃-monoethylamine and BF₃-acetoacetanilide, phosphoric acid and triphenyiphosphine. Tertiary amines, Mannich bases and imidazoles are preferred.

In addition, the resin can contain ductility improvers, such as carboxyl-terminated polybutadienes or core-shell particles, as well as thixotropic agents, for example ones based on a urea derivative in a nondiffusing carrier material. Advantageously, this thixotropic agent contains a blocked polyurethane prepolymer as carrier material. The preparation of such urea derivatives and carrier materials are described in detail in EP 1 152 019 A1.

### 2) Polyisocyanates and Polyol or Polyamine Hardeners

Suitable systems are, for example:

Polyoxyalkylene polyols, also called polyether polyols, which are the polymerization products of ethylene oxide, 1,2-propylene oxide, 1,2- or 2,3-butylene oxide, tetrahydrofuran and mixtures thereof, optionally polymerized with the help of a starter molecule that has two or three active H atoms such as water or compounds with two or three OH groups. Both polyoxyalkylene polyols that have a low degree of unsaturation (measured in accordance with ASTM D-2849-69 and given in milliequivalents of unsaturation per gram of polyol (meq/g)), prepared, for example, with the help of the so called Double Metal Cyanide Complex Catalysts (DMC Catalysts), and also polyoxyalkylene polyols with a higher degree of unsaturation, which are prepared for example with the help of anionic catalysts like NaOH, KOH or alkali alcoholates, can be used. Polyoxypropylenediols and -triols with degree of unsaturation below 0.02 meq/g and molecular weight from 1000 to 30,000 g/mol, polyoxybutylenediols and triols, polyoxypropylenediols and triols with molecular weight from 400 to 8000 g/mol, as well as the so call “EO-end capped” (ethylene oxide-end capped) polyoxypropylenediols or -triols are particularly suitable. The latter are particular polyoxypropylene polyoxyethylene polyols, which can be obtained, for example, by alkoxylating pure polyoxypropylene polyols after completion of the polypropoxylation with ethylene oxide and which because of that have primary hydroxyl groups.

Polyhydroxy-terminated polybutadiene polyols, such as those prepared by polymerization of 1,3-butadiene and allyl alcohol;

Styrene-acrylonitrile grafted polyether polyols, for instance those sold by Bayer under the name Lupranol;

Polyhydroxy-terminated acrylonitrile/polybutadiene copolymers, as can be prepared, for example, for carboxyl-terminated acrylonitrile/polybutadiene copolymers (commercially obtainable under the name Hycar® CTBN Hanse Chemie) and epoxides or from amino alcohols;

Polyester polyols, prepared, for example, from dihydric to trihyric alcohols such as 1,2-ethanediol, diethylene glycol, 1,2-propanediol, dipropylene glycol, 1,4-butanediol, 1-5-pentanediol, 1,6-hexanediol, neopentyl glycol, glycerol, 1,1,1-trimethylolpropane or mixtures of said alcohols with organic dicarboxylic acids or their anhydrides or esters such as succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid or mixtures of said acids, as well as polyester polyols from lactones such as ε-caprolactone;

Polycarbonate polyols, such as are obtainable by the reaction of, for example, said alcohols (those used for synthesis of the polyester polyols) with dialkyl carbonates, diaryl carbonates or phosgene.

Advantageously, the isocyanate-reactive polymers are difunctional or more highly functional polyols with OH equivalent weights from 600 to 6000 g/OH-equivalent, especially from 600 to 4000 g/OH-equivalent, preferably 700 to 2200 g/OH-equivalent. Moreover, the polyols are advantageously chosen from the group consisting of polyethylene glycols, polypropylene glycols, polyethylene glycol polypropylene glycol block copolymers, polybutylene glycols, hydroxyl-terminated polybutadienes, hydroxyl-terminated polybutadiene-coacrylonitriles, hydroxyl-terminated synthetic rubbers and mixtures of the said polyols.

Moreover, difunctional or more highly functional amine-terminated polyethylene ethers, polypropylene ethers, polybutylene ethers, polybutadienes, polybutadiene/acrylonitriles (for example, Hycar® CTBN from Hanse Chemie), and other amine-terminated synthetic rubbers or mixtures of the said components can be used as isocyanate-reactive polymers.

It is further possible for the isocyanate-reactive polymers to also be chain-lengthened, such as can be prepared from the reaction of polyamines, polyol and polyisocyanates, especially diamines, diols and diisocyanates, in the way that is well known to the specialist.

Polyols with molecular weights between 600 and 6000 g/mol, chosen from the group consisting of polyethylene glycols, polypropylene glycols, polyethylene glycol-polypropylene glycol block copolymers, polybutylene glycols, hydroxyl-terminated polybutadienes, hydroxyl-terminated polybutadiene-acrylonitrile copolymer and their mixtures are preferred as isocyanate-reactive polymers.

Especially preferred as isocyanate-reactive polymers are α, ω-polyalkylene glycols with C₂—C₆ alkylene groups or with mixed C₂—C₆ alkylene groups that are terminated with amino, thiol or, preferably hydroxyl groups. Polypropylene glycol and polybutylene glycol are especially preferred.

Diisocyanates, triisocyanates or tetraisocyanates, especially di- or triisocyanates, are suitable as polyisocyanates. Diisocyanates are preferred. Aliphatic, cycloaliphatic, aromatic or araliphatic diisocyanates are suitable as diisocyanates, especially the commercial products like methylenediphenyl diisocyanate (MDI), hexamethylene diisocyanate (HDI), toluene diisocyanate (TDI), tolidine diisocyanate (TODI), isophorone diisocyanate (IPDI), trimethylhexamethylene diisocyanate (TMDI), 2,5- or 2,6-bis(isocyanatomethyl)bicyclo[2.2.1]heptane, 1,5-naphthalene diisocyanate (NDI), dicyclohexylmethyl diisocyanate(H₁₂MDI), p-phenylene diisocyanate (PPDI), m-tetramethylxylylene diisocyanate (TMXDI), and their dimers. HDI, IPDI, TMDl, MDI and TDI are preferred.

Suitable triisocyanates are in particular trimers or biurets of aliphatic, cycloaliphatic, aromatic or araliphatic diisocyanates, especially the isocyanurates and biurets of the diisocyanates described in the previous paragraph.

Additionally suitable are particles of solid polyisocyanates that have been deactivated at the surface, as are described in R. Blum and H. Schupp, Progress in Organic Coatings (1990) pp. 275-288.

### 3) Acrylates and Methacrylates and Microencapsulated Radical Initiators

Suitable systems are described, for example, in the application WO 02/070620 A1 and the literature indicated therein. They consist of methacrylic acid esters like methyl methacrylate and tetrahydrofurfuryl methacrylate as well as aliphatic polyurethane acrylates, elastomers reacted with acrylic acid such as polybutadiene-acrylonitrile-copolymers (trade name Hycar® VTBNX) or core-shell polymers. Other suitable systems, which essentially consist of mixtures of methacrylates with elastomers, are described U.S. Pat. No. 3,890,407, U.S. Pat. No. 4,106,971 and U.S. Pat. No. 4,263,419, for example. Possibilities as initiators are in particular organic peroxides, especially benzoyl peroxide in combination with catalysts like tertiary amines and/or complexes or salts of transitions metals. Examples of tertiary amines are N,N-dimethylbenzylamine and N-alkylmorpholine. Examples of complexes or salts of transitions metals are complexes or salts of nickel, cobalt and copper.

The preparation of microencapsulated radical initiators like peroxides is described, for example in EP 0 730 493 B1.

Use of the Fastening Elements:

According to FIG. 1 the fastening elements 1 are placed in a fastening device 2. The fastening element 1 is pressed against the base element 5, for example a construction surface of glass, steel, concrete, etc., by means of the fastening device. The fastening device is designed so that the adhesive can be heated. The way the heating takes place is dependent on the adhesive system and can take place, for example, by induction, thejinal radiation, etc. In the case of the two-component systems described above with components separated by membranes 8 and 10 (see FIGS. 4 and 5) said components are released with the rupturing elements 7 when the fastening element is pressed against the base element. The adhesive is now heated through the fastening device, which leads to rapid hardening. This heating is advantageously done by means of alternating fields like conduction or microwaves. Particles with ferromagnetic, ferrimagnetic, superparamagnetic or piezoelectric properties are arranged in the adhesive as described above and are heated by the radiation. Advantageously, these particles are nanoparticles. Rapid hardening is possible through the radiation-induced heating of the adhesive, without the surroundings also being heated.

If rapid hardening is not possible because of the type of adhesive that is chosen, a temporary adhesion to the base element can be produced by means of auxiliary adhesives 6 arranged on the fastening element 1, until the adhesion is taken on by the [primary] adhesive.

After sufficient adhesion has formed between the fastening element and the base element, the fastening device can be removed from the fastening element. After hardening is complete or when sufficient force has developed, other elements can be placed on the fastening element. In the construction field these can be, for example, roof elements, glazings, insulations, conduits, and so forth. The reactive adhesive of the fastening element can additionally also be covered by a cover that is removed before processing. This is especially advantageous when the fastening element has auxiliary adhesives.

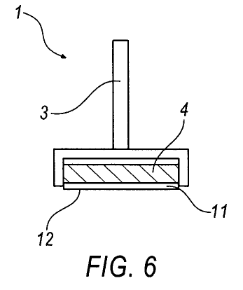

According to FIG. 6 a primer layer or auxiliary adhesive layer 11 can additionally be applied to the fastening element 1. Such a primer or auxiliary adhesive layer 11 can be situated between the fastening element 1 and the adhesive 4 and/or on the adhesive as shown. Perhaps another protective mechanism will have to be arranged between the adhesive layer and the primer or auxiliary adhesive layer, so that these layers do not react with each other prematurely.

In order to protect layer 12 until the fastening element 1 is used a protective layer 12 is advantageously arranged on layer 11. It can be removed before the use of the fastening element 1, or it can be used analogously to the rupturing element 7 shown in FIG. 3.

Primers based on isocyanates, epoxides, acrylates or silanes are especially suitable as primers. Primers based on epoxide resins are especially well suited for porous substrates. Typically, such primers contain solvents, especially aromatic solvents like xylene, toluene or White spirit, or ketones like methyl ethyl ketone, or alcohols like methanol or ethanol or isopropanol. It is clear to the specialist that the solvent is chosen so that it does not react with the functional groups present in the primary in each case, i.e., isocyanates, epoxide or silane. In addition, primers can typically contain fillers, especially carbon black.

Compositions that contain silanes, titanates and/or zirconates are especially suitable as adhesion aids. Such silanes, titanates and/or zirconates are characterized by the fact that they have at least one functional group that is bonded to a silicon, titanium or zirconium atom. In addition, such silanes, titanates and/or zirconates preferably have at least one organic substituent that is bonded via a carbon-silicon or carbon-titanium or carbon-zirconium bond to the silicon, titanium or zirconium atom. Alkoxysilanes, especially trialkoxysilanes that, have at least one, preferably one organic substituent are especially preferred. Adhesion aid compositions additionally preferably contain a solvent that has a boiling point that is preferably lower than 100° C. Preferred solvents are alcohols, especially isopropanol.

Instead of the mechanical rupturing elements to rupture the membrane or other (protective) layers it is also possible to use thermal methods, in which ferrites, for example, are incorporated into the membranes or layers that are to be ruptured. These ferrites can be stimulated by the appropriate electromagnetic fields, and are heated and thus destroy the membrane. The membranes or layers can also be adjusted by means of their melting point so that they readily melt and thus are easily destroyed.

Of course, the invention is not limited to the indicated and described embodiment examples.

### REFERENCE NUMBER LIST

1 Fastening element
2 Fastening device
3 Mounting support
4 Reactive glue
5 Base elements
6 Auxiliary adhesive
7 Rupturing element
8 Container
9 Absorbent material
10 Membrane
11 Primer or auxiliary adhesive layer
12 Protective layer

1. A fastening element for fastening to a base element such as a construction surface, the fastening element comprising:
a mount; and
a reactive adhesive disposed on the mount.

2. The fastening element of claim 1, further comprising an auxiliary adhesive for affixing the fastening element to the base element.

3-21. (canceled)

22. The fastening element of claim 1, further comprising particles arranged in the reactive adhesive, said particles operable to be stimulated by alternating fields.

23. The fastening element of claim 1, wherein the reactive adhesive is a one-component reactive adhesive comprising a resin and a hardener;
wherein at least one of the resin and the hardener is blocked; and
wherein the resin comprises one of:
a polyurethane polymer that contains an isocyanate group,
a monomer that contains an acryl or methacryl group, and
a polyepoxide.

24. The fastening element of claim 4, wherein the resin and the hardener are blocked; and wherein the resin comprises a blocked polyurethane polymer containing at least one isocyanate group.

25. The fastening element of claim 4, wherein the one-component reactive adhesive comprises at least one polyurethane polymer including:
at least one blocked isocyanate group;
at least one blocked hardener;
a plurality of particles, said particles having one of ferromagnetic, ferrimagnetic, superparamagnetic and piezoelectric properties; and
at least one additive.

26. The fastening element of claim 4, wherein the one-component reactive adhesive comprises:
at least one monomer including:
one of acryl and methacryl groups; and
at least one blocked hardener;
a plurality of particles having one of ferromagnetic, ferrimagnetic, superparamagnetic and piezoelectric properties; and
at least one additive.

27. The fastening element of claim 1, wherein the reactive adhesive is a two-component reactive adhesive, wherein the components of the two-component reactive adhesive are separated by at least one membrane.

28. The fastening element of claim 8, wherein at least one component of the two-component reactive adhesive is one of microencapsulated, absorbed in an absorbent material, and packaged within a film material.

29. The fastening element of claim 8, wherein the two-component reactive adhesive comprises at least one of an epoxide resin system, a polyisocyanate system, and an acrylate system.

30. The fastening element of claim 8, further comprising a rupturing element operable to rupture the membrane.

31. The fastening element of claim 1, further comprising a cover associated with the reactive adhesive, said cover operable to be removed before use.

32. The fastening element of claim 1, further comprising one of a primer and an auxiliary adhesive layer (11).

33. The fastening element of claim 13, further comprising a protective layer (12) covering the one of the primer and the auxiliary adhesive layer (11).

34. A method, comprising:
pressing a fastening element against a base element with a fastening device;
applying an alternating field to a reactive adhesive disposed on the fastening element with the fastening device;
wherein the reactive adhesive is heated, thereby hardening the reactive adhesive.

35. The method of claim 15, further comprising holding the fastening element on the base element with an auxiliary adhesive disposed on the fastening element while the reactive adhesive is hardening.

36. The method of claim 16, wherein the auxiliary adhesive comprises one of a primer and an auxiliary adhesive layer (11).

37. A method, comprising:
providing a fastening element with a reactive adhesive comprising at least two components, said components separated by a membrane;
pressing a fastening element onto a base element with a fastening device;
rupturing the membrane;
applying an alternating field to the reactive adhesive through the fastening device;
wherein the reactive adhesive is heated, thereby hardening the reactive adhesive.

38. The method of claim 18, wherein at least one membrane separating the components is at least one of mechanically ruptured and thermally ruptured.

39. The method of claim 18, further comprising holding the fastening element on the base element with an auxiliary adhesive while the reactive adhesive is hardening.

40. The method of claim 20, wherein the auxiliary adhesive comprises one of a primer and an auxiliary adhesive layer (11).
